(19) United States
(12) Patent Application Publication
(10) Pub. No.: US 2020/0005658 A1
(43) Pub. Date: Jan. 2, 2020

(54) Electronic Health and Nutrition Educational Toy

(71) Applicant: Elisa Elaine Douglas, Roselle, NJ (US)

(72) Inventor: Elisa Elaine Douglas, Roselle, NJ (US)

(21) Appl. No.: 16/423,199

(22) Filed: May 28, 2019

Related U.S. Application Data
(60) Provisional application No. 62/677,254, filed on May 29, 2018.

(51) Int. Cl. G09B 5/04; G09B 19/00

(52) U.S. Cl. CPC G09B 5/04; G09B 19/0084; G09B 19/0092

(57) ABSTRACT

An electronic health and nutrition education toy created to teach children the importance of eating healthy foods and engaging in physical activities daily. The invention was created with five buttons at its front, with each labeled either MORNING, NOON, EVENING, NIGHT or YAY, and each play a pre-recorded audio message when pressed. All the buttons, except the YAY button, will teach children the best foods to eat at that particular time of the day and the physical activities they should engage in at that time. Additionally, the MORNING button teaches the importance of washing hands while the NIGHT button also teaches the importance of good oral hygiene. The YAY button was created to offer words of praise when users engage in a healthy activity. The buttons were created in colors that are bright and appealing to children and the invention can work either while lying down or standing upright.

### RELATED APPLICATIONS

The present application claims priority to U.S. provisional patent application No. 62/677,254, filed on May 29, 2018. The entire disclosure is included herein in its entirety at least by reference.

### BACKGROUND OF THE INVENTION

This invention is an electronic educational toy designed to teach children about healthy lifestyle habits, namely, good nutrition, regular exercise/physical activities, good oral hygiene, and the benefits of these habits. A healthy lifestyle involves the habits that help to keep and improve an individual's overall health and wellbeing. Some ways for people to be healthy include eating healthy foods, engaging in moderate to vigorous physical activities at least thirty minutes daily, maintaining a healthy weight, and effectively managing stress.

This invention therefore comprises education about all the primary aspects of a healthy lifestyle that are important for children to learn at an early age so that they can stay healthy as they grow older. This invention is therefore unlike any other invention that has been invented to date because this is currently the only toy that does not teach about only one aspect of a healthy lifestyle, such as nutrition, but instead, it educates about all components of this lifestyle that children can control with little or no help from an adult or older sibling.

A large percentage of children today are affected by chronic diseases, such as obesity, diabetes and heart disease, but the risk of diagnoses of these diseases can be dramatically reduced by healthy lifestyle habits. According to the American Academy of Pediatrics, ten to twenty million children and adolescents in the United States have some type of chronic illness or disability and the Centers for Disease Control and Prevention (CDC) has reported that 13.9% of children ages two to five years and 18.4% of children ages six to eleven years old are obese. Furthermore, the American Diabetes Association has reported that an estimated 193,000 Americans under age 20 years have been diagnosed with diabetes. Similarly, the National Institute of Dental and Craniofacial Health, a division of the National Institutes of Health (NIH), has reported that 42% of children ages two to eleven have had tooth decay.

It is therefore crucial that children be taught at an early age the importance of eating healthy foods and exercising daily so that they can know how to prevent getting these chronic diseases as they grow older.

### BRIEF SUMMARY OF THE INVENTION

This invention is an electronic toy that was created to teach children about healthy lifestyle habits. These habits include eating healthy foods, exercising daily and proper oral hygiene. The invention has five labeled buttons at the front, and when pressed, each button will play a pre-recorded audio message. All five buttons are at the front of the toy and one of the buttons, labeled YAY, has a pre-recorded message, which praises children for engaging in a healthy habit. These audio messages also explain the benefits of eating healthy foods from the different food groups, as well as the benefits of exercising daily. The NIGHT button further encourages children to floss and brush their teeth before bed, and to drink only water after brushing, at bedtime.

This invention is intended to educate children about the best practices to live a healthy lifestyle during each part of the day, namely, morning, afternoon, evening, and bedtime. This invention is currently in the shape of a penguin, an animal that is loved and admired by children, which will therefore add to the appeal of the toy and consequently, children will likely want to use this invention daily. Subsequent versions of this invention will be created to look like other living things (such as other animals and people) that children find appealing and can easily relate to.

### BRIEF DESCRIPTION OF THE DRAWINGS

FIG. 1 shows the front view of the invention, in its current plastic housing, which is currently designed to look like a penguin, complete with eyes, beak, feet and arms. The dots below the beak of the penguin indicates the speaker holes and the five buttons shown, labeled MORNING, NOON, EVENING, NIGHT and YAY, will play pre-recorded audio files when pressed. The feet allow the penguin to stand when it is in the upright position.

FIG. 2 shows the side view of the overall plastic housing of the toy, including its eyes and beak, and with its soft, round edges, the speaker holes, and the labeled buttons at the front, which play the pre-recorded messages when pressed.

FIG. 3 shows the rear view of the toy, which includes the battery compartment door and the volume button to its left.

FIG. 4 shows the side view of the invention, including its body, one of its arms, its beak, and one foot.

FIG. 5 shows the exploded front view of the invention with the different sections that make up the toy. The far left image in the diagram shows the battery compartment door and the two AA batteries that are required to make the invention work. Next is the back housing, followed by the speaker and the circuit board assembly. The buttons that are located at the front of the invention are next in the diagram, followed by an image of the front housing of the toy and its beak. Below is an image of the feet, which serves as a stand when the toy is upright.

Please refer to the attached black and white drawings of this electronic health and nutrition educational toy.

### DETAILED DESCRIPTION OF THE INVENTION

The inventor provides an electronic health and nutrition educational toy that is currently in the shape of a penguin. This toy has five labeled buttons at the front of it with one of the following words on each button: MORNING, NOON, EVENING, NIGHT and YAY. The present invention is described in enabling detail in the following examples, which may represent more than one embodiment of the present invention.

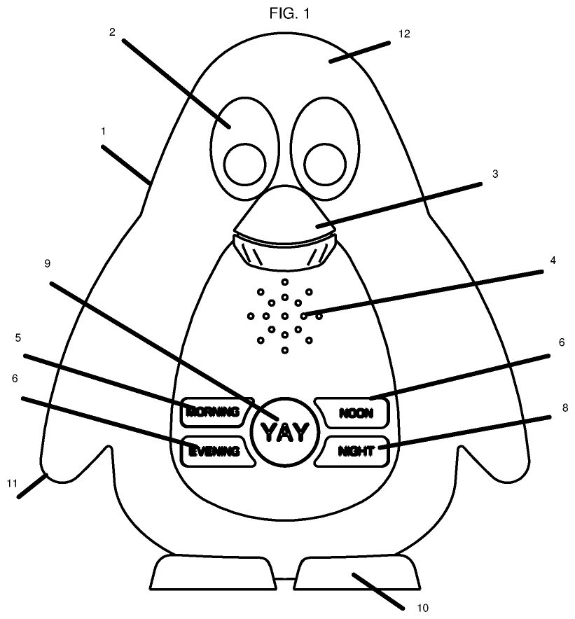

FIG. 1 shows the front view of the invention, in its current plastic housing 1, which is currently designed to look like a penguin, complete with eyes 2, beak 3, feet 10 and arms 11. The entire housing 1, including the arms 11 of the penguin, have soft and round edges that make the product safe for children to use. The dots below the beak 3 of the penguin indicates the speaker holes 4 and the five buttons shown, labeled MORNING 5, NOON 6, EVENING 7, NIGHT 8 and YAY 9, will play pre-recorded audio files when pressed, along with background music specific to each file. The feet 10 allow the penguin to stand when it is in the upright position. The speaker holes 4 will enable users to hear the pre-recorded audio files, which are played when each button is pressed. Each audio file is specific to each button and gives nutrition and exercise tips that are appropriate for each specified time of the day. Each button will also tell the benefits of eating the recommended food items for children at that specific time of the day. The NIGHT 8 button also gives advice related to dental/oral care. The background music that is played when each button is pressed is either soft and relaxing or live and upbeat based on the time of day indicated on the button that is pressed.

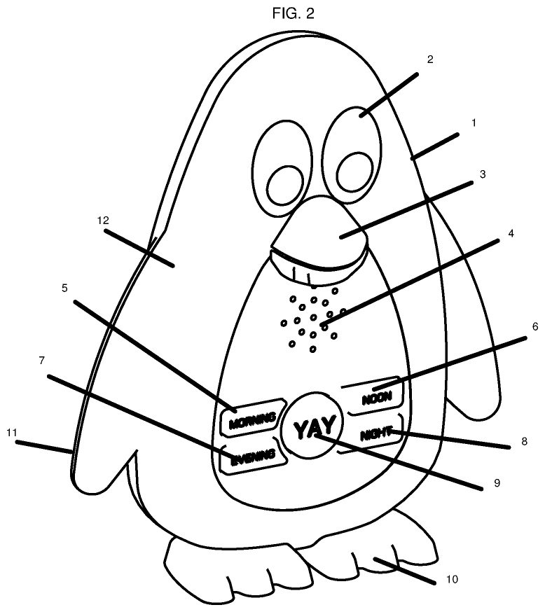

FIG. 2 shows the side view of the overall plastic housing of the invention 1, and also includes its eyes 2 and beak 3, its soft, round edges, the speaker holes 4, and the labeled buttons at the front 5, 6, 7, 8 and 9, which play the pre-recorded messages when pressed. This invention was made from durable hard plastic but it was created with smooth edges that makes its entire surface smooth to the touch and, therefore, child-friendly.

Each button on the invention has a different color, each of which is bright and appealing to young learners. The words on the current invention were created in upper-case letters in black ink with the use of hot stamp, which makes them more durable and less likely to fade over time. However, other embodiments of this invention may include the writings on the buttons in different colors and the use of materials other than hot stamp, such as embroidery and the use of a hot foil pen/hot stamping pen.

The YAY button 9 is in the middle of the other four buttons, with the MORNING 5 and EVENING 7 buttons on its left and the NOON 6 and NIGHT 8 buttons on its right. The color of the MORNING button 5 is yellow. The color of the NOON button 6 is green. The color of the EVENING button 7 is blue, the color of the NIGHT button 8 is purple and the YAY button 9 is in the color red. Please refer to FIGS. 1 and 2 to see the five-labeled buttons.

The YAY button 9 was created to offer words of praise when users engage in a healthy activity, such as eating a healthy food, engaging in a physical activity, washing their hands, or brushing their teeth.

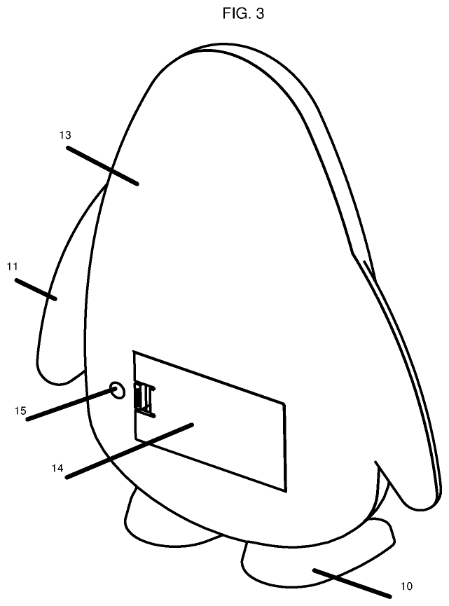

FIG. 3 shows the rear view of the invention, which includes the battery compartment door 14 and the volume button 15 to its left. This current invention does not have a power button but its volume button 15 has eight different levels of sound and is the small circular object at the back of the invention, and is also currently black in color, as seen in FIG. 3. However, another embodiment of the invention may have a power button, in lieu of or in addition to a volume button 15. The current invention requires two AA batteries 16 to work. The battery compartment door 14 is kept closed with a screw and therefore requires a screwdriver to open, which provides an extra layer of safety for children who will use this invention.

This toy was invented with the purpose of educating users about healthy lifestyle habits: eating healthy foods within the confines of a balanced diet and engaging in physical activities daily. It will help users learn about and understand the importance of these healthy behaviors so that these behaviors will become lifestyle habits, as these users grow older. These healthy lifestyle activities can help prevent overweight, obesity, and many different chronic diseases including diabetes, hypertension and heart disease. This invention will also help parents who are having a difficult time getting their children to eat healthy foods. This is because this invention will not only tell users that they should eat healthy and nutritious foods, but also informs them of the benefits of eating these foods, that is, this invention explains how eating healthy foods benefit the mind, body, and the overall growth and development of children and adolescents.

Additionally, this invention will educate users about how to keep their teeth healthy by explaining why it is important to regularly brush and floss one's teeth. This is based on the belief that if children learn at an early age how to adequately care for their teeth, then they will grow up with healthy, beautiful teeth and consequently, they will not experience the problems that are associated with poor teeth health, such as plague and gum disease. If users follow the instructions/advise given by this invention, they are more likely to have a better and brighter smile with less trips to the dentist, which can be very expensive and time-consuming.

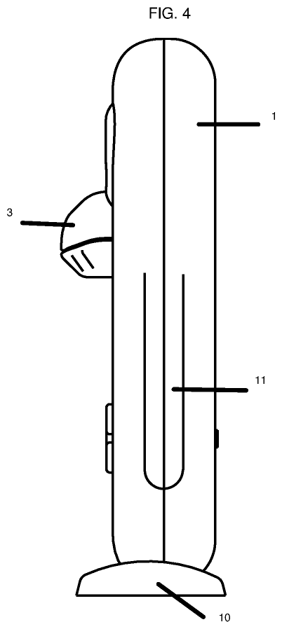

FIG. 4 shows the side view of the invention, including its body 1, one of its arms 11, its beak 3, and one foot 10. The invention, in its current shape of a penguin, was made with soft, round edges, which makes it smooth to the touch and perfectly safe for children to use, as can be seen in the side view shown in FIG. 4. As previously mentioned, the invention was created in the shape of a living object with a face so that the housing would be more relatable to children.

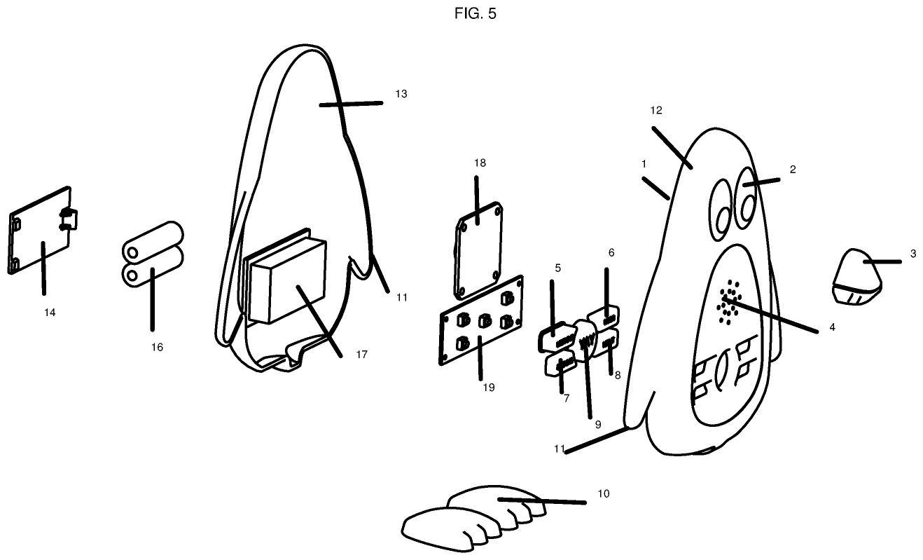

FIG. 5 shows the exploded front view of the invention with the different sections that make up the toy. The different parts of its housing 1, which is currently in the shape of a penguin, are therefore shown in FIG. 5. The far left image in the diagram shows the battery door and the two AA batteries 16 that are required to make the toy work. Next is the back housing 13 with the battery housing 17, followed by the speaker 18 and circuit board assembly 19. The buttons that are located at the front of the invention, MORNING 5, NOON 6, EVENING 7, NIGHT 8 and YAY 9, which will play their respective pre-recorded messages when pressed are next in the diagram, followed by an image of the front housing of the invention 12 with its eyes 2, speaker holes 4 and arms 11. The last part of the diagram shown to the far right of the diagram in exploded view is the beak 3. At the bottom of the diagram is an image of the feet of the penguin 10, which serves as a stand when the invention is upright.

The buttons on the invention will play the following pre-recorded audio messages when pressed, along with low background music specific to each button:
MORNING Button: Good morning! Rain or shine . . . it's a beautiful day! Remember . . . have some milk and fruit with your breakfast. A healthy breakfast will give you energy to learn and play! Wash your hands often today to keep germs away. Count to 20 or sing the alphabet song when you wash your hands. Now . . . get ready to start your day! Make today your best day ever!
   NOON Button: Good afternoon! I'm glad you're having a great day so far! Remember . . . drink only 100% juice and no sodas! Whether inside or out, move around, play, and have fun! This will help you to learn and sleep better so you can grow big and strong! Now . . . have some lunch, wait a few minutes, then run along and play!
EVENING Button: Good evening! I hope you had the most amazing day ever! Remember . . . eat foods with protein, iron and vitamins for dinner. Vitamins will keep you healthy and will heal your cuts and bruises quickly, while proteins and iron will give you the energy you need to play and learn new things! Some milk with your dinner will do you a world of good too! Milk will give you healthy bones, teeth, eyes and skin.
NIGHT Button: So it's time for bed, huh? Well, you had a very busy day so you must be exhausted! Remember . . . floss and brush your teeth before bed to prevent cavities. Drink only water after you brush! Good night! Sweet dreams!
YAY! Button: Yay!!! You did it!! Great job!!

Other embodiments of this invention will not only be made in the shape of other living things, such as different animals and people, but will also provide education on other topics related to health and nutrition, such as the five food groups, different types of physical activities to engage in, ‘sometimes’ foods versus ‘everyday’ foods, how to lose weight if you are overweight or obese, how to gain weight if you are underweight, how often to visit the dentist and the best types of toothbrush to use, self-esteem, safety, mental health, among other topics that children and their parents can learn from to live healthier lives.

The current embodiment of this invention is made with hard plastic but future versions may also be made with the use of other materials, including plush toys made from stuffing materials such as synthetic fiber, cotton, wood wool, plastic pellets, straw and beans. The current words on the buttons will also change in future versions to words such as ‘exercise’, ‘nutrition’, ‘oral care’, ‘self-esteem’, ‘mental health’, ‘safety’, ‘sleep’, and etcetera. The colors of the buttons will also change in future embodiments of this invention. This invention will also be made in different sizes, and not just one standard size. There are many possibilities.

This invention was created to build a strong foundation for children regarding how to live a healthy lifestyle as well as to act as a guide for parents in terms of what they should allow their children to eat and drink and why they should ensure that their children engage in physical activities on a daily basis.

It will be apparent to one with skill in the art that this electronic health and nutrition educational toy may be provided using some or all of the mentioned features and components without departing from the scope and spirit of the present invention. It will also be apparent to the skilled artisan that the other embodiments described above are specific examples of a single broader invention, which may have greater scope than any of the singular descriptions taught. There may be many alterations made in the descriptions without departing from the spirit and scope of the present invention.

1. The invention claimed is an electronic toy that provides health and nutrition education, comprising of the following:
A MORNING button with a pre-recorded audio message that encourages children to have some milk and fruit with their breakfast and to wash their hands for at least 20 seconds;
A NOON button with a pre-recorded audio message that encourages children to drink 100% juice and no sodas and move around whether they are inside or outside;
An EVENING button with a pre-recorded audio message that encourages children to eat foods with protein, iron and vitamins for dinner, to drink some milk, and how these foods will benefit their bodies;
A NIGHT button with a pre-recorded audio message that encourages children to floss and brush their teeth before bed and to drink only water after they brush; and
A YAY button with a pre-recorded audio message that offers words of support and praise.

2. An electronic educational toy as recited in claim 1, wherein provides education on the best foods to eat based on the time of day, recommends different health-related activities to engage in throughout the day, from morning to night, and explains the benefits of each recommended health-related activity.

3. An electronic educational toy as recited in claim 1, wherein teaches the importance of washing one's hands and how long to wash one's hands for.

4. An electronic educational toy as recited in claim 1, further comprising of five labeled buttons at the front of the toy with one of the following words on each button: MORNING, NOON, EVENING, NIGHT and YAY.

5. An electronic educational toy as recited in claim 1, wherein the words on each button on the invention were created only in upper-case letters in black text with the use of hot stamp.

6. An electronic educational toy as recited in claim 1, wherein the YAY button is between the other four buttons, with the MORNING and EVENING buttons on its left and the NOON and NIGHT buttons on its right.

7. An electronic educational toy as recited in claim 1, wherein each button on the invention was created in a different color, as follows:
The color of the MORNING button is yellow;
The color of the NOON button is green;
The color of the EVENING button is blue;
The color of the NIGHT button is purple; and
The color of the YAY! button is red.

8. An electronic educational toy as recited in claim 1, further comprising the following pre-recorded audio messages when each specified button is pressed:
The MORNING button: Good morning! Rain or shine . . . it's a beautiful day! Remember . . . have some milk and fruit with your breakfast. A healthy breakfast will give you energy to learn and play! Wash your hands often today to keep germs away. Count to 20 or sing the alphabet song when you wash your hands. Now . . . get ready to start your day! Make today your best day ever;
The NOON button: Good afternoon! I'm glad you're having a great day so far! Remember . . . drink only 100% juice and no sodas! Whether inside or out, move around, play, and have fun! This will help you to learn and sleep better so you can grow big and strong! Now . . . have some lunch, wait a few minutes, then run along and play;
The EVENING button: Good evening! I hope you had the most amazing day ever! Remember . . . eat foods with protein, iron and vitamins for dinner. Vitamins will keep you healthy and will heal your cuts and bruises quickly, while proteins and iron will give you the energy you need to play and learn new things! Some milk with your dinner will do you a world of good too! Milk will give you healthy bones, teeth, eyes and skin;
The NIGHT button: So it's time for bed, huh? Well, you had a very busy day so you must be exhausted! Remember . . . floss and brush your teeth before bed to prevent cavities. Drink only water after you brush! Good night! Sweet dreams;
The YAY! button: Yay!!! You did it!! Great job.

9. An electronic educational toy as recited in claim 1, further providing education on teeth health and teaches how to take care of one's teeth.

10. An electronic educational toy as recited in claim 1, wherein the labeled buttons on the invention will play the corresponding pre-recorded message when a button is pressed either while the invention is positioned lying down or standing upright. The current invention plays only one pre-recorded message at a time.

11. An electronic educational toy as recited in claim 1, wherein the labeled buttons on the invention will play pre-recorded background music along with the pre-recorded messages when pressed.
